(19) United States
(12) Patent Application Publication
(10) Pub. No.: US 2026/0247163 A1
(43) Pub. Date: Aug. 20, 2026

(54) METHOD TO IMPROVE WIRELESS NETWORK COVERAGE, ELECTRONIC DEVICE AND COMPUTER READABLE STORAGE MEDIUM

(71) Applicant: Nanning FuLian FuGui Precision Industrial Co., Ltd., Nanning (CN)

(72) Inventor: JIAN-YOU GUO, Hsinchu City (TW)

(21) Appl. No.: 19/055,736

(22) Filed: Feb. 18, 2025

(51) Int. Cl. H04W 16/20; H04B 7/0452; H04W 40/24; H04W 84/12; H04W 84/18

(52) U.S. Cl. CPC H04W 16/20; H04B 7/0452; H04W 40/246; H04W 84/12; H04W 84/18

(57) ABSTRACT

A method to improve wireless network coverage, an electronic device and a computer readable storage medium are disclosed. A site map of a wireless network area is imported. A plurality of network sharing devices in the wireless network area are scanned by a radio frequency scanner according to the site map to form a Wi-Fi mesh network. A service set identifier (SSID) and quality of service (QoS) table, a white channel table and a multiple device support table are generated according to the Wi-Fi mesh network. One or more of these network sharing devices are allocated to users to connect to the Internet through multi-user multiple input multiple output (MU-MIMO) technology according to the SSID and QoS table, the white channel table and the multiple device support table.

### FIELD

The disclosure relates to a network connecting method, and more particularly to a method to improve wireless network coverage, an electronic device and a computer readable storage medium.

### BACKGROUND

Signal strength and quality and of indoor Wi-Fi signals depend on the number, location and power of Wi-Fi hotspots. Due to cost considerations, some large spaces, such as offices, shopping malls, factories, etc., are difficult to fully cover with signals, resulting in unsatisfactory communication quality.

### BRIEF DESCRIPTION OF THE DRAWINGS

Many aspects of the present disclosure can be better understood with reference to the following figures. The components in the figures are not necessarily drawn to scale, the emphasis instead being placed upon clearly illustrating the principles of the present disclosure. Moreover, in the drawings, like reference numerals designate corresponding parts throughout the several views. Implementations of the present technology will now be described, by way of embodiments, with reference to the attached figures, wherein:

FIG. 1 is a schematic diagram of an embodiment of ceiling-mounted network sharing devices used in an office of the present invention;

FIG. 2 is a schematic diagram of an embodiment of ceiling-mounted network sharing devices used in a building of the present invention;

FIG. 3 is a flowchart of an embodiment of a method to improve wireless network coverage of the present disclosure;

FIG. 4 is a block diagram of an embodiment of the hardware architecture of an electronic device using the method of the present disclosure; and

FIG. 5 is a block diagram of an embodiment of functional blocks of an electronic device of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “comprising,” when utilized, means “including, but not necessarily limited to”; it specifically indicates open-ended inclusion or membership in the so-described combination, group, series, and the like.

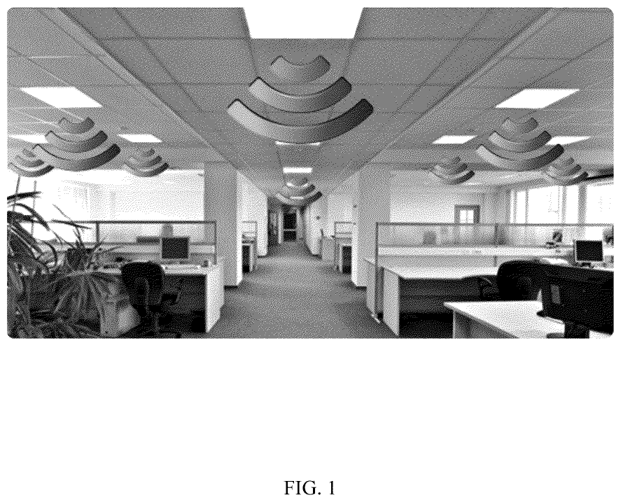

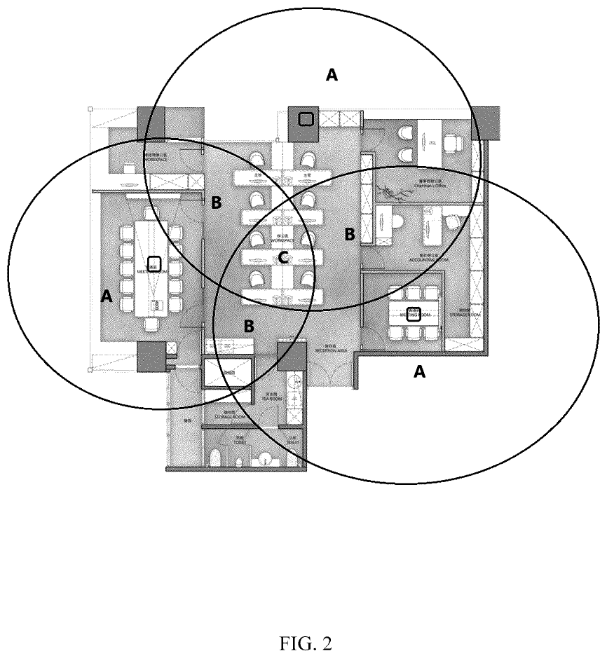

FIG. 1 is a schematic diagram of an embodiment of ceiling-mounted network sharing devices used in an office of the present invention. FIG. 2 is a schematic diagram of an embodiment of ceiling-mounted network sharing devices used in a building of the present invention. An embodiment of a method to improve wireless network coverage is applied to network sharing devices with hotspot functions, such as ceiling-mounted Wi-Fi access points (APs), ceiling-mounted Wi-Fi routers or other non-ceiling-mounted network sharing devices. Referring to FIG. 2, the location of the user A is covered by wireless signals of only one network sharing device, the location of the user B is covered by wireless signals of two network sharing devices, and the location of the user C is covered by wireless signals of three network sharing devices.

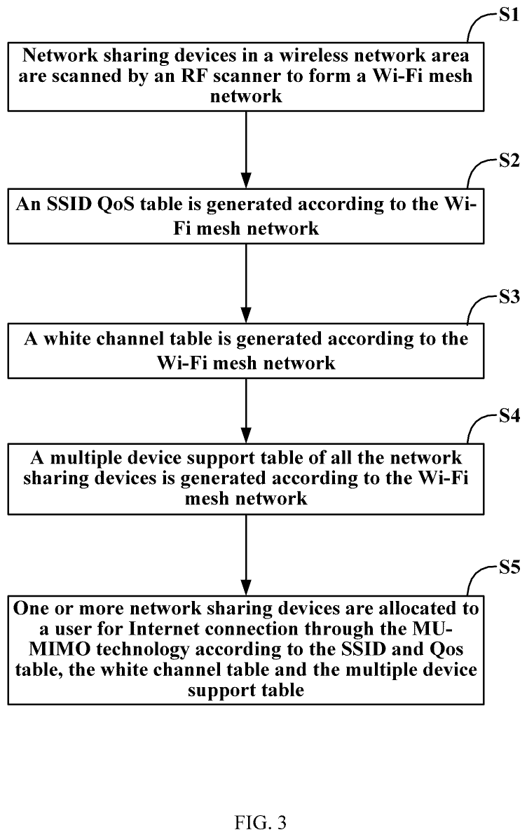

FIG. 3 is a flowchart of an embodiment of a method to improve wireless network coverage of the present disclosure. According to different needs, the order of the steps in the flowchart can be changed, and some steps can be omitted.

In step S1, a site map of a wireless network area is imported, and a plurality of network sharing devices in the wireless network area are scanned by a radio frequency (RF) scanner according to the site map to form a Wi-Fi mesh network.

In step S2, a service set identifier (SSID) and quality of service (QoS) table is generated according to the Wi-Fi mesh network. Each SSID corresponds to a network sharing device, and the network sharing devices are sorted according to throughputs of each of the network sharing devices.

In step S3, a white channel table is generated according to the Wi-Fi mesh network. A received signal strength indication (RSSI) value of a network sharing device in the white channel table is less than 70 decibel relative to one milliwatt (dBm).

For example, a 2 GHz to 7.1 GHz wireless scanner is used as a spectrum analyzer to scan the wireless network area at regular intervals (eg, 1 min) to obtain frequency bands used in the wireless network area, thereby generating the white channel table. The white channel table includes frequency bands recommended for use by network sharing devices (the channels with RSSI<−70 dBm). For example, a network sharing device 1 provides a bandwidth of 40 million bits per second (Mbps) in the 2G band through a channel 3 (ch3) (2G_40M_ch3), a network sharing device 2 provides a bandwidth of 80 Mbps in the 5G band through a channel 80 (ch80) (5G_80M_ch80), and a network sharing device 3 provides a bandwidth of 160 Mbps in the 6G band through a channel 57 (ch27) (6G_160M_ch57).

In step S4, a multiple device support table of all the network sharing devices is generated according to the Wi-Fi mesh network. In the Wi-Fi mesh network, each user's sub-area in the wireless network area may be covered by the wireless signals of 1, 2 or 3 network sharing devices. The multiple device support table indicates a sub-area where each user is located can be covered by the wireless signals of how many network sharing devices. In other words, a user who is covered by the wireless signals of multiple network sharing devices can preferentially select one or more network sharing devices with better signals to transmit data.

In step S5, one or more network sharing devices are allocated to a user for Internet connection through the multi-user multiple input multiple output (MU-MIMO) technology according to the SSID and QoS table, the white channel table and the multiple device support table.

The following is an example to illustrate an embodiment of an implementation process of the method for improving the wireless network coverage of the present invention.

For example, users A and C require 320M bandwidth respectively, and users B and D require 160M bandwidth respectively. It is known that users C and D can be supported by three network sharing devices by referring to the multiple device support table while the bandwidth required by the user C is greater than the bandwidth required by the user D, so that the user C has a higher priority than the user D.

It can be known that the network sharing devices 1 to 4 can currently provide network sharing services according to the white channel table. The network sharing device 1 provides a bandwidth of 20 Mbps to 320 Mbps (6G_20M→320M_ch57) in the 6G band through the channel 57 (ch57), the network sharing device 2 provides a bandwidth of 20 Mbps to 320 Mbps in the 5GH band through the channel 114 (ch114) (5G_20M→160M_ch114), the network sharing device 3 provides a bandwidth of 20 Mbps to 80 Mbps in the 5GL band through channel 50 (ch50) (5G_20M→80M_ch50), and the network sharing device 4 provides a bandwidth of 20 Mbps to 40 Mbps in the 2G band through the channel 9 (ch9) (2G_20M→40M_ch9).

The order of bandwidth allocation of the users A, B, C, and D is C→D→A→B Based on the bandwidth requirements and whether they are supported by multiple network sharing devices. The bandwidth allocation information is shown as follows:
User C: 160M from the network sharing device 1+80M from the network sharing device 2+80M from the network sharing device 3;
User D: 80M from the network sharing device 1+40M from the network sharing device 2+40M from the network sharing device 3;
User A: 320M from the network sharing device 1; and
User B: 160M from the network sharing device 1.

In addition, it should be noted that the present invention uses methods familiar to those skilled in the art to generate the SSID and QoS table, the white channel table and the multiple device support table, which will not be described in detail herein.

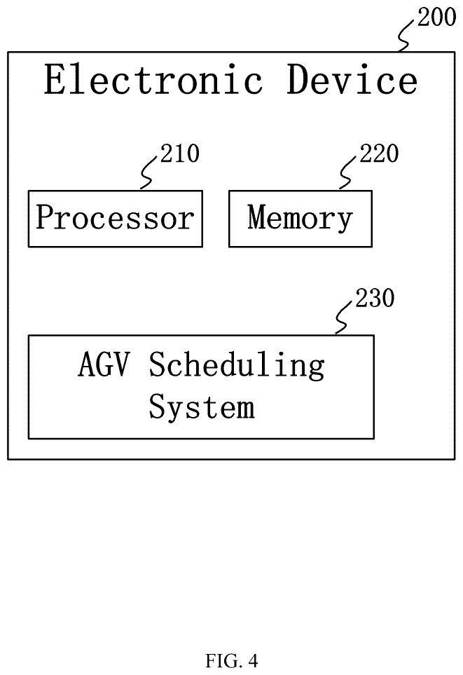

FIG. 4 is a block diagram of an embodiment of the hardware architecture of an electronic device using the method to improve wireless network coverage of the present disclosure. The electronic device 200 may be, but is not limited to, connected to a processor 210, a memory 220, and a system to improve wireless network coverage 230 via system buses. The electronic device 200 shown in FIG. 4 may include more or fewer components than those illustrated or may combine certain components.

The memory 220 stores a computer program, such as the system to improve wireless network coverage 230, which is executable by the processor 210. When the processor 210 executes the system to improve wireless network coverage 230, the blocks in one embodiment of the booting mode configuration method applied in the electronic device 200 are implemented, such as blocks S1 to S5 shown in FIG. 3.

It will be understood by those skilled in the art that FIG. 4 is merely an example of the electronic device 200 and does not constitute a limitation to the electronic device 200. The electronic device 200 may include more or fewer components than those illustrated or may combine certain components. The electronic device 200 may also include input and output devices, network access devices, buses, and the like.

The processor 210 may be a central processing unit (CPU), or other general-purpose processors, a digital signal processor (DSP), an application specific integrated circuit (ASIC), a Field-Programmable Gate Array (FPGA), or another programmable logic device, discrete gate or transistor logic device, discrete hardware components, or the like. The processor 210 may be a microprocessor or other processor known in the art.

The memory 220 can be used to store the system to improve wireless network coverage 230 and/or modules/units by running or executing computer programs and/or modules/units stored in the memory 220. The memory 220 may include a storage program area and a storage data area. In addition, the memory 220 may include a high-speed random access memory, a non-volatile memory such as a hard disk, a plug-in hard disk, a smart memory card (SMC), and a secure digital (SD) card, flash card, at least one disk storage device, flash device, or another volatile solid state storage device.

The system to improve wireless network coverage 230 can be partitioned into one or more modules/units that are stored in the memory 220 and executed by the processor 210. The one or more modules/units may be a series of computer program instructions capable of performing particular functions of the system to improve wireless network coverage 230.

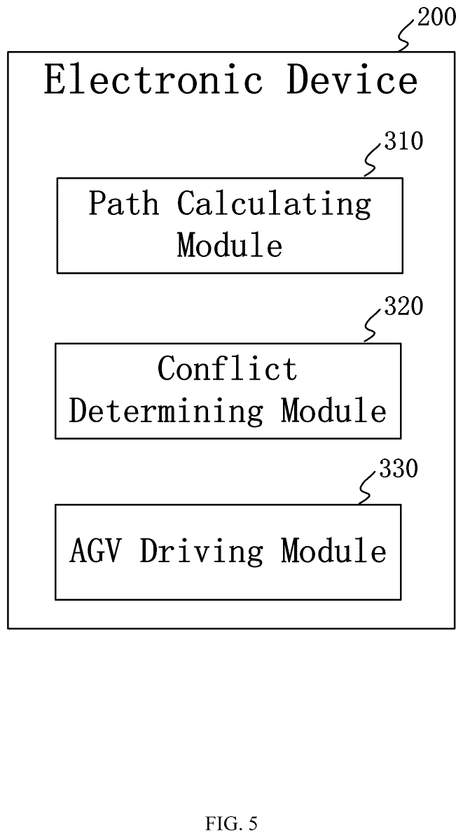

FIG. 5 is a schematic diagram of an embodiment of functional blocks of the electronic device using the method of the present disclosure.

The electronic device 200 comprises a network building module 310, a data building module 320 and a network management module 330.

The network building module 310 imports a site map of a wireless network area, and scans a plurality of network sharing devices in the wireless network area using a RF scanner according to the site map to form a Wi-Fi mesh network.

The data building module 320 generates an SSID and QoS table according to the Wi-Fi mesh network. Each SSID corresponds to a network sharing device, and the network sharing devices are sorted according to throughputs of each of the network sharing devices.

The data building module 320 generates a white channel table according to the Wi-Fi mesh network. The RSSI value of a network sharing device in the white channel table is less than 70 dBm.

For example, a 2 GHz to 7.1 GHz wireless scanner is used as a spectrum analyzer to scan the wireless network area at regular intervals (eg, 1 min) to obtain frequency bands used in the wireless network area, thereby generating the white channel table. The white channel table includes frequency bands recommended for use by network sharing devices (the channels with RSSI<−70 dBm). For example, a network sharing device 1 provides a bandwidth of 40 million bits per second (Mbps) in the 2G band through a channel 3 (ch3) (2G 40M_ch3), a network sharing device 2 provides a bandwidth of 80 Mbps in the 5G band through a channel 80 (ch80) (5G_80M_ch80), and a network sharing device 3 provides a bandwidth of 160 Mbps in the 6G band through a channel 57 (ch27) (6G_160M_ch57).

The data building module 320 generates a multiple device support table of all the network sharing devices according to the Wi-Fi mesh network. In the Wi-Fi mesh network, each user's sub-area in the wireless network area may be covered by the wireless signals of 1, 2 or 3 network sharing devices. The multiple device support table indicates a sub-area where each user is located can be covered by the wireless signals of how many network sharing devices. In other words, a user who is covered by the wireless signals of multiple network sharing devices can preferentially select one or more network sharing devices with better signals to transmit data.

The network management module 330 allocates one or more network sharing devices to a user for Internet connection through the MU-MIMO technology according to the SSID and QoS table, the white channel table and the multiple device support table.

It is to be understood, however, that even though numerous characteristics and advantages of the present disclosure have been set forth in the foregoing description, together with details of the structure and function of the present disclosure, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A method to improve wireless network coverage executable by an electronic device, comprising:
importing a site map of a wireless network area and scanning a plurality of network sharing devices in the wireless network area by a radio frequency (RF) scanner according to the site map to form a Wi-Fi mesh network;
generating a service set identifier (SSID) and quality of service (QoS) table according to the Wi-Fi mesh network
generating a white channel table according to the Wi-Fi mesh network, wherein a received signal strength indication (RSSI) value of a network sharing device in the white channel table is less than 70 decibel relative to one milliwatt (dBm);
generating a multiple device support table of all the network sharing devices according to the Wi-Fi mesh network, wherein the multiple device support table describes a sub-area where each user is located is covered by wireless signals of how many network sharing devices; and
allocating one or more network sharing devices to a user for Internet connection through the multi-user multiple input multiple output (MU-MIMO) technology according to the SSID and QoS table, the white channel table and the multiple device support table.

2. The method of claim 1, wherein each SSID in the SSID and QoS table corresponds to a network sharing device, the method further comprises:
sorting the network sharing devices according to throughputs of each of the network sharing devices.

3. An electronic device, which includes a memory, a processor, and a serial number length adjustment program stored in the memory and operable on the processor, wherein the wireless network coverage improvement program is executed by the processor to implement following steps:

4. The device of claim 3, wherein each SSID in the SSID and QoS table corresponds to a network sharing device, the wireless network coverage improvement program is further executed by the processor to implement following steps:
sorting the network sharing devices according to throughputs of each of the network sharing devices.

5. A non-transitory computer-readable storage medium storing game program which causes a computer to execute:
a process of importing a site map of a wireless network area and scanning a plurality of network sharing devices in the wireless network area by a radio frequency (RF) scanner according to the site map to form a Wi-Fi mesh network;
a process of generating a service set identifier (SSID) and quality of service (QoS) table according to the Wi-Fi mesh network
a process of generating a white channel table according to the Wi-Fi mesh network, wherein a received signal strength indication (RSSI) value of a network sharing device in the white channel table is less than 70 decibel relative to one milliwatt (dBm);
a process of generating a multiple device support table of all the network sharing devices according to the Wi-Fi mesh network, wherein the multiple device support table describes a sub-area where each user is located is covered by wireless signals of how many network sharing devices; and
a process of allocating one or more network sharing devices to a user for Internet connection through the multi-user multiple input multiple output (MU-MIMO) technology according to the SSID and QoS table, the white channel table and the multiple device support table.

6. The non-transitory computer-readable storage medium of claim 5, wherein each SSID in the SSID and QoS table corresponds to a network sharing device, and the wireless network coverage improvement program is further executed by the processor to implement following steps:
a process of sorting the network sharing devices according to throughputs of each of the network sharing devices.
